(19) United States
(12) Patent Application Publication
(10) Pub. No.: US 2003/0132613 A1
(43) Pub. Date: Jul. 17, 2003

(54) FOLDING ELEMENT FOR A FRONT WHEEL OF THREE-WHEELED GOLF CART

(76) Inventor: Liz Lin, San Diego, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/045,144

(22) Filed: Jan. 15, 2002

(51) Int. Cl. B62B 1/00

(52) U.S. Cl. 280/651; 280/639

(57) ABSTRACT

A folding element for a golf cart front wheel includes a pair of parallel connecting parts, a positioning member and a pulled button. The connecting parts stick out from a supporting base at a lower end of the cart frame. One of the connecting parts has a pivotal hole and several holes spaced out around the pivotal hole in a circular pattern. The positioning member is connected to a support fork of the front wheel and has a through hole lengthwise formed therein and holes spaced out around the through hole to correspond to the circularly-arranged holes. The positioning member is turnably positioned between the connecting parts with a pivotal rod being connected to the connecting parts and passing through the trough hole of the positioning member. The pulled button has fixing poles and a spring biasing the same toward the positioning member for the fixing poles to engage the circularly-arranged holes. The pulled button can be pulled against the spring for the fixing poles to separate from the circularly-arranged holes of the positioning member so that the positioning member combined with the front wheel can be turned about the pivotal rod between a stretched in-use position and a folded not-in-use one where the golf cart has reduced size.

### BACKGROUND OF THE INVENTION

The present invention relates to a folding element for a front wheel of a three-wheeled golf cart and more particularly, to a folding element for the front wheel that consists of a positioning member turnably fitted onto the main frame of the golf cart and firmly connected to the front wheel so as to allow the front wheel to move to a not-in-use position for reducing the dimension of the golf cart when the cart is not used.

Many methods have been devised for folding golf carts so that the golf carts have reduced size for easy storage and transportation. However, in most of the conventional folding methods, the folding of a golf cart for reducing the size of the golf cart are limited to the handle and the support rods of two lateral wheels, excluding the front wheel. Therefore, the front wheel still sticks our from the other parts of the folded golf cart in such a manner as to make the golf cart not ideally compact in the folded not-in-use position.

### SUMMARY OF THE INVENTION

Therefore, it is a main object of the present invention to provide a folding element for the front wheel of a golf cart so as to allow the front wheel to be moved to a desired position for reducing the size of the golf cart when the cart is not used.

The folding element for a golf cart front wheel of the present invention includes a pair of parallel connecting parts, a positioning member and a pulled button.

The connecting parts stick out from the rear side of a supporting base positioned at the lower end of a golf cart frame. One of the connecting parts has a pivotal hole and several holes spaced out around the pivotal hole in a circular pattern. The positioning member is connected to a support fork, which the front wheel is fitted to, and has a through hole lengthwise formed therein and holes spaced out around the through holes also in a circular pattern to correspond to the circularly-arranged holes of the connecting part.

The positioning member is turnably positioned between the connecting parts with a pivotal rod being connected to the connected part and passing through the through hole of the positioning member.

The pulled button has fixing poles facing the positioning member and is connected to a spring biasing the same toward the positioning member for the fixing poles to engage the circularly-arranged holes. The pulled button can be pulled away from the positioning member against the biasing force of the spring for the fixing poles to separate from the circularly-arranged holes of the positioning member so that the positioning member joined with the front wheel can be turned about the pivotal rod between a stretched in-use position and a folded not-in-use one where the golf cart has further reduced size after the other parts of the golf cart have been folded for easy storage of the cart.

### BRIEF DESCRIPTION OF THE DRAWINGS

This invention will be better understood by referring to the accompanying drawings, wherein:

FIG. 1 is an exploded perspective view of the folding element for a front wheel of a golf cart according to the present invention.

FIG. 2 is a perspective view of the combined supporting base and folding element for a front wheel according to the present invention.

FIG. 3 is a cross-sectional view of the folding element for a golf cart front wheel according to the present invention in the locking position.

FIG. 4 is a cross-sectional view of the folding element for a golf cart front wheel according to the present invention in the unlocking position.

FIG. 5 is a side view of the folding element of the present invention in the folded position.

### DETAILED DESCRIPTION OF THE PREFERRED EMBODIMENT

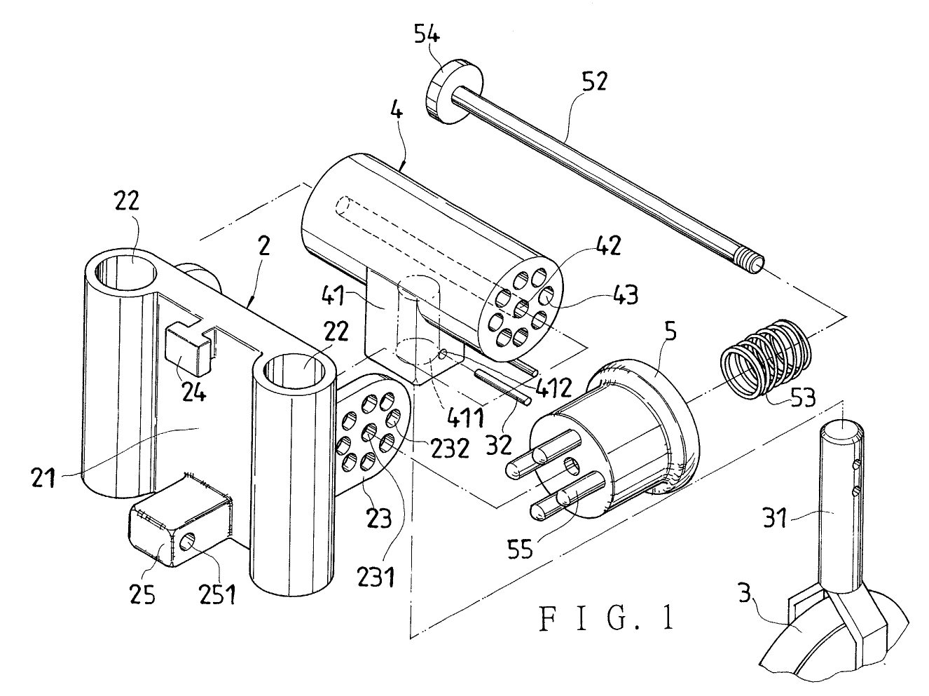

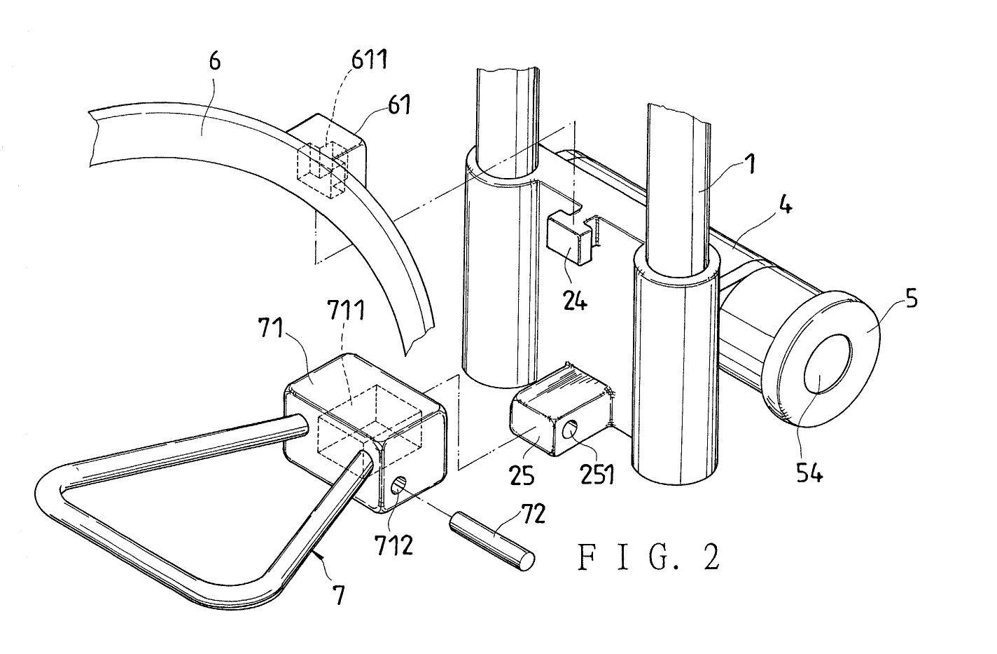

Referring to FIGS. 1 and 2, the main frame of a golf cart according to the present invention includes a pair of support rods 1, a supporting base 2, a fixing member 6 and a holding member 7. The supporting base 2 has a board part 21, and two through holes 22 defined by two separate tubes formed at two sides of the board part 21. The lower ends of the support rods 1 are fixedly passed into the through holes 22 for joining the support rods 1 to the supporting base 2. The supporting base 2 further has an engaging block 24 and a connecting block 25 at an upper part and a lower part of the front surface respectively.

The fixing member 6 has a curved main body (not numbered), a connecting block 61 formed on the middle of the curved main body and having an engaging trench 611 with the same shape as the engaging bock 24. The fixing member 6 is connected to the base 2 with the engaging trench 611 being mounted on the engaging block 24. The holding member 7 has a holding part (not numbered), and a connecting block 71 at the rear end of the holding part; the holding member 7 is connected to the support base 2 with a connecting room 711 of the connecting block 71 being mounted on the connecting block 25 of the base 2; a securing pin 72 is passed into both a hole 712 of the connecting block 71 and a through hole 251 of the connecting block 25 to secure the holding member 7 in position. Thus, a golf bag can be held on the main frame by means of the holding member 7, the fixing member 6 and the support rods 1. The main frame of course has connecting rods for the lateral wheel, a handle, etc. however, they are not shown or detailed here because they are not the subject of the present invention.

Now we move on the main part of the present invention, i.e. the folding element for the front wheel. Referring again to FIG. 1, the folding element includes a pair of parallel connecting parts 23 sticking out from the rear surface of the supporting base 2, a positioning member 4, a pulled button 5, a spring 53 and a pivotal rod 52.

The connecting parts 23 each has a pivotal hole 231 in the middle, and one of the connecting parts 23 (the right one in FIG. 1) further has several through holes 232 spaced out around the pivotal hole 231 to form a circle.

The positioning member 4 has a cylindrical main part (not numbered), and a connecting part 41 sticking out from the cylindrical part. The cylindrical part has a pivotal through hole 42 lengthwise formed in the middle, and holes 43 spaced out around the pivotal hole 42 to form a circle and corresponding to the connecting holes 232. The connecting part 41 has a connecting hole 411, and a through hole 412 communicating with the hole 411. The front wheel 3 of the golf cart is connected to a fork (not numbered), which is connected to a connecting rod 31 from the upper end. The connecting rod 31 is secured to the positioning member 4 with the upper end portion thereof being passed into the connecting hole 411 of the connecting part 41; a securing pin 32 is passed through the hole 412 and a hole (not numbered) of the rod 31.

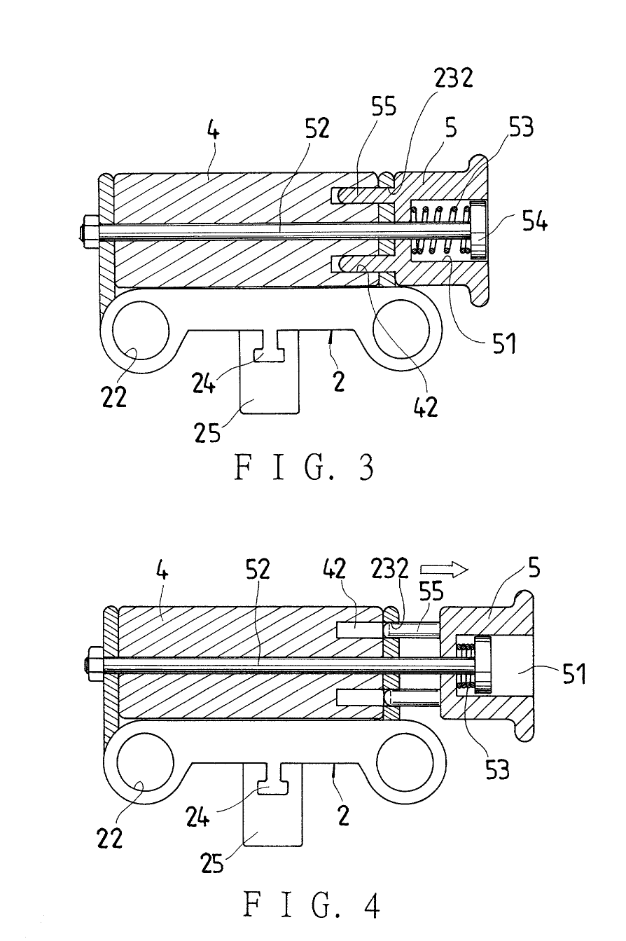

The pulled button 5 has a central hole (not numbered) and fixing poles 55 formed around the central hole on the inner side. The pulled button 5 further has a holding room 51 (FIGS. 3 and 4) on the outer side and communicating with the central hole. The pivotal rod 52 has a head 54 which has larger diameter than the rest of the rod 52.

In combination, the positioning member 4 is positioned between, and turnably connected to, the connecting parts 23 with the pivotal rod 52 being passed through the left one of the connecting parts 23, the pivotal through hole 42 and the right connecting part 23 in sequence. The pulled button 5 is connected to the right connecting part 23 and the positioning member 4 with the fixing poles 55 passing through the through holes 232 of the right connecting part 23 and the holes 43 of the positioning member 4; thus, the pivotal rod 52 passed through the central hole of the pulled button 5 into the holding room 51. The pivotal rod 52 further passes through the spring 53, which is received in the holding room 51, and is connected to a retaining member 54 (FIGS. 3 and 4) at the tail end for preventing the spring 53 from falling out.

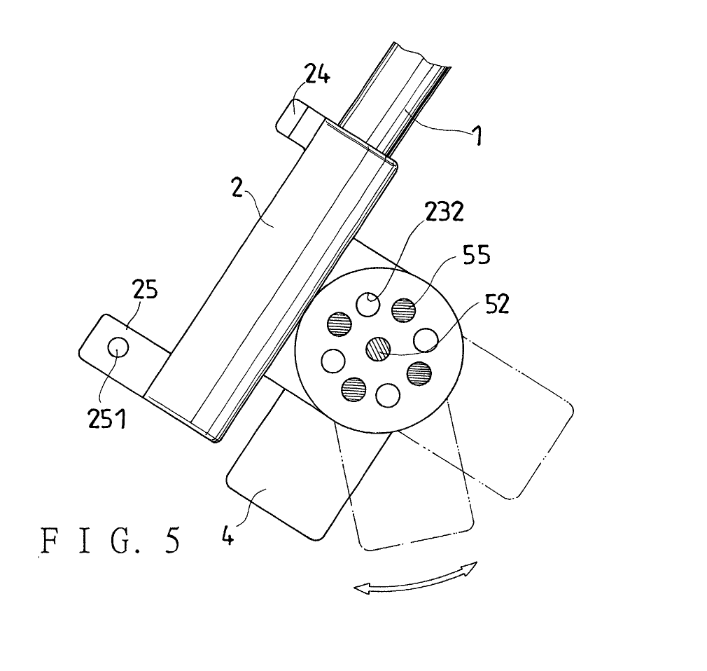

Thus, referring to FIG. 5, the fixing poles 55 of pulled button 5 normally engage the through holes 232 and the holes 43 in a locking position to prevent the positioning member 4 from turning about the pivotal rod 52, while when the golf cart needs to be folded for storage, the pulled button 5 is pulled away from the positioning member 4 to an unlocking position where the fixing poles 55 separate from the holes 43 of the positioning member 4 so as to allow the positioning member 4 to be turned about the pivotal rod 52 for changing the position of the front wheel 3 to one suitable for storage. When the positioning member 4 is turned to the desired position in folding of the golf cart, the pulled button 5 is released and biased toward the positioning member by the spring 53 to be connected with the positioning member 4 again, i.e. in the locking position.

From the above description, it can be easily understood that the golf cart having the front wheel folding element of the present invention can be easily folded to a further reduced size for storage and transportation with the help of the front wheel folding element, after the other parts of the golf cart such as the handle and the connecting rods for the lateral wheels have be folded.

What is claimed is:

1. A folding element for a front wheel of a golf cart;
said golf cart having a main frame including a supporting base at a lower part;
said front wheel being connected to a fork member connected to a connecting rod from an upper end of said fork member;
said folding element comprising
a pair of parallel first and second connecting parts sticking out from a first side of said supporting base; said first connecting part having a pivotal hole; said second connecting part having a pivotal hole aligned with said pivotal hole of said first one and having a plurality of holes spaced out around said pivotal hole thereof in a circular pattern;
a positioning member having a pivotal through hole lengthwise formed therein, and holes spaced out around said pivotal hole thereof in a circular pattern to correspond to said circularly-arranged holes of said second connecting part; said positioning member being disposed between, and turnably connected to, said first and said second connecting parts by means of a pivotal rod passing through said pivotal holes of said connecting parts and said positioning member; said connecting rod of said front wheel being secured to said positioning member;
a pulled button having a central hole and a plurality of fixing poles on one side; said pulled button being separably connected to said positioning member with said fixing poles passing through said circularly-arranged holes of both said second connecting part and said positioning member to prevent said positioning member from turning about said pivotal rod; said pivotal rod being passed through said central hole of said pulled button and connected to a spring positioned on other side of said pulled button; said spring biasing said button toward said positioning member so as to cause said fixing poles to pass into said circularly-arranged holes of said positioning member;
whereby said front wheel can be moved between an in-use stretched position and a not-in-use folded position by means of turning said positioning member about said pivotal rod after said pulled button has being pulled to disengage from said positioning member.

2. The folding element for a front wheel of a golf cart as claimed in claim 1, wherein said supporting base has an engaging block sticking out from a second side opposite to said first side thereof; a fixing member for a golf bag being connected to said supporting base with an engaging trench thereof being mounted on said engaging block.

3. The folding element for a front wheel of a golf cart as claimed in claim 1, wherein said supporting base has a connecting block sticking out from a second side opposite to said first base; a holding member for a golf bag being connected to said supporting base with a hollow connecting block thereof being mounted on said connecting block of said base and with a securing pin being passed into both said connecting blocks.

4. The folding element for a front wheel of a golf cart as claimed in claim 1, wherein said positioning member has a connecting part having a connecting hole and a through hole communicating with said connecting hole; said connecting rod of said front wheel being secured to said connecting hole of said positioning member connecting part by means of a securing pin passing through said through hole of said positioning member connecting part and into said connecting rod.
